(19) United States
(12) Patent Application Publication
(10) Pub. No.: US 2017/0204258 A1
(43) Pub. Date: Jul. 20, 2017

(54) MICROPULP-ELASTOMER MASTERBATCHES AND COMPOUNDS

(71) Applicant: E I DU PONT DE NEMOURS AND COMPANY, Wilmington, DE (US)

(72) Inventors: Mark F. Teasley, LANDENBERG, PA (US); Jeffrey S. Downey, BATTERSEA (CA); GOVINDASAMY PARAMASIVAM RAJENDRAN, Garnet Valley, PA (US)

(21) Appl. No.: 15/478,662

(22) Filed: Apr. 4, 2017

Related U.S. Application Data
(62) Division of application No. 15/120,779, filed on Aug. 23, 2016.
(60) Provisional application No. 61/945,243, filed on Feb. 27, 2014.
(60) Provisional application No. 62/025,222, filed on Jul. 16, 2014.

(51) Int. Cl. C08L 9/06; C08L 7/02; C08K 7/02

(52) U.S. Cl. CPC C08L 9/06; C08K 7/02; C08L 7/02; C08L 2310/00; C08K 2201/004; C08K 2201/006; C08L 2205/16

(57) ABSTRACT

A masterbatch composition of elastomer and from 20 to 100 parts per hundred parts elastomer of fibrous micropulp wherein the micropulp has fibers with a volume weighted average fiber length of from 20 to 200 micrometers as measured by laser diffraction, a relative specific surface area of from 30 to 600 square meter per gram as measured by nuclear magnetic resonance and the fibers selected from the group consisting of aromatic polyamide, aromatic copolyamide, polyacrylonitrile and polyazole.

### BACKGROUND

1. Field of the Invention

This invention pertains to a masterbatch comprising an elastomer and a fibrous micropulp.

2. Description of Related Art

Para-aramid pulp such as Kevlar® pulp is a fibrillated fiber product that is manufactured from yarn by chopping into staple then mechanically abrading in water to partially shatter the fibers. This leads to a large increase in surface area as fibrils with diameters as low as 0.1 micrometer (μm) are attached to the surface of the main fibers, which are typically 12 micrometers in diameter. Kevlar® pulps must be kept moist to prevent the fibrillated structure from collapsing if they are to be highly dispersible in different matrices. U.S. Pat. Nos. 5,084,136 and 5,171,402 describe such para-aramid pulps. Para-aramid fiber products are available under the registered trademark Kevlar® from E. I. Du Pont de Nemours and Company, Wilmington, Del. (DuPont).

These pulps are used, for example, as fillers in elastomer compounds to modify their tensile properties. The largest application is in natural rubber for tire reinforcement. The moist pulps are dispersed into water and mixed with elastomer latexes then coagulated to give concentrated masterbatches. An exemplary masterbatch comprising para-aramid fibrous pulp and elastomer is commercially available as DuPont Kevlar® Engineered Elastomer (EE) from E.I. du Pont de Nemours and Company, Wilmington, Del. Kevlar® EE masterbatches contain the pulp in a highly dispersed state that can be compounded into bulk elastomer to give the desired level of pulp modification. Suitable merges of Kevlar® EE are 1F722, 1F724, 1F723, 1F735, 1F1234, 1F819, 1F770, and F1598.

In tire reinforcement, the various rubber components are subjected to different levels of strain. Currently, Kevlar® EE is limited to those components that are exposed to lower levels of strain. Kevlar® EE-rubber compounds typically show higher initial modulus than neat rubber with a pronounced yield point. In this context, the term “yield point” describes a discontinuity in the measured stress over the range of about 20 to 100% strain, in which the slope of the tensile curve rapidly decreases, in some cases to near a plateau. This yield point has been associated with a loss of adhesion between fiber and rubber.

U.S. Pat. No. 5,576,104 to Causa et al describes how partially oriented yarns (POY), when processed into short fibers and used as a fiber reinforcement in an elastomer, have been found to demonstrate reduced crack propagation in the elastomer. POY reinforced elastomers can be used in tires to replace cord reinforced components, and for example, can be used in the tread base of a tire, obviating the need for an overlay ply. In one embodiment it has been found that the properties of a fiber reinforced elastomer can be optimized by using a mixture of partially oriented fibers and fibrillated pulp fibers, such as pulped high modulus rigid rod liquid crystalline fibers, as the fiber reinforcement.

U.S. Pat. No. 8,211,272 to Levit discloses para-aramid pulp including meta-aramid fibrids for use as reinforcement material in products including for example friction materials, fluid sealing materials, and papers. The invention further relates to processes for making such pulp.

United State patent application publication 2001/0006086 to Benko teaches elastomeric formulations for use in tires that include aramid pulp and elastomers among the ingredients.

US patent application publication US 2003/0114641 A1 to Kelly discloses micropulp prepared from para-aramid fibers and pulps for use as thixotrope and reinforcement material in coating compositions.

### BRIEF DESCRIPTION OF THE DRAWINGS

FIG. 1 is a graph of representative stress/percent elongation curves for pulps and micropulps in natural rubbers.

FIG. 2 is a graph of representative stress/percent elongation curves for pulps and micropulps in synthetic rubbers.

FIG. 3 is a graph of representative stress/percent elongation curves for pulps and micropulps containing PVP in synthetic rubbers.

### DETAILED DESCRIPTION

There is a need for pulps that can reinforce tire components and other rubber goods while permitting them to experience higher levels of stress or strain. The applicants have unexpectedly discovered that masterbatches containing the henceforth described micropulps provide unprecedented reinforcement in vulcanized rubber compounds to surprisingly higher levels of strain than for the Kevlar® EE-rubber compounds of the prior art. Typically, the micropulp-rubber compounds show higher initial modulus than neat vulcanized rubber compounds with the absence of the characteristic yield point of the Kevlar® EE-rubber compounds of the prior art.

### Masterbatch

A masterbatch composition of this invention comprises elastomer and from 1 to 100 parts per hundred parts elastomer of fibrous micropulp.

### Micropulp

The micropulp comprises fibers having a volume weighted average fiber length of from 20 to 200 micrometers as measured by laser diffraction and has a relative specific surface area of from 30 to 600 square meter per gram as measured by nuclear magnetic resonance, preferably 40 to 500 square meter per gram. In some embodiments, the relative specific surface area of the micropulp is from 40 to 250 square meter per gram, preferably from 50 to 150 square meter pergram. In yet other embodiments, the relative specific surface area is 250 to 500 square meter per gram, preferably 300 to 400 square meter per gram.

Preferably, the micropulp fibers have a volume weighted average fiber length of from 20 to 100 micrometers, more preferably of from 40 to 100 micrometers. In some embodiments the pulp is a never-dried micropulp, prepared from wet as-spun fibers that are saturated with water and have never been dried.

### Fiber

The micropulp is prepared from fiber by chopping into staple or floc then wet milling in water to completely shatter the fibers into their constituent fibrils. Optionally, the staple or floc can first be converted into pulp to aid the wet milling process. The fiber is in the form of a continuous filament. For purposes herein, the term “filament” is defined as a relatively flexible, macroscopically homogeneous body having a high ratio of length to width across its cross-sectional area perpendicular to its length. The filament cross section can be any shape, but is typically round or bean shaped. Multifilament yarn spun onto a bobbin in a package contains a plurality of continuous filaments. In the context of this disclosure, the terms filament and fiber may be used interchangeably. Other suitable forms of fibrous material are a staple spun yarn, a nonwoven fabric, or chopped yarn strand. A plurality of filaments or yarns may be combined to form a cord. These terms are well known in the textile fibers art.

The fibers of the micropulp may be aromatic polyamide, aromatic copolyamide, polyazole, or polyacrylonitrile.

A preferred aromatic polyamide is para-aramid by virtue of having exceptional tensile strength and modulus. As used herein, the term para-aramid filaments means filaments made of para-aramid polymer. The term aramid means a polyamide wherein at least 85% of the amide (—CONH—) linkages are attached directly to two aromatic rings. Suitable para-aramid fibers and their properties are described in Man-Made Fibres—Science and Technology, Volume 2, in the section titled Fibre-Forming Aromatic Polyamides, page 297, W. Black et al., Interscience Publishers, 1968. Aramid fibers and their production are, also, disclosed in U.S. Pat. Nos. 3,767,756; 4,172,938; 3,869,429; 3,869,430; 3,819,587; 3,673,143; 3,354,127; and 3,094,511. Para-aramid fibers are particularly suited for the manufacture of pulp and micropulp due to their fibrillar morphology.

A preferred para-aramid is poly (p-phenylene terephthalamide) which is called PPD-T. By PPD-T is meant the homopolymer resulting from mole-for-mole polymerization of p-phenylene diamine and terephthaloyl chloride and, also, copolymers resulting from incorporation of small amounts of other diamines with the p-phenylene diamine and of small amounts of other diacid chlorides with the terephthaloyl chloride. As a general rule, other diamines and other diacid chlorides can be used in amounts up to as much as about 10 mole percent of the p-phenylene diamine or the terephthaloyl chloride, or perhaps slightly higher, provided only that the other diamines and diacid chlorides have no reactive groups which interfere with the polymerization reaction. PPD-T, also, means copolymers resulting from incorporation of other aromatic diamines and other aromatic diacid chlorides such as, for example, 2,6-naphthaloyl chloride or chloro- or dichloroterephthaloyl chloride or 3,4′-diaminodiphenylether. Additives can be used with the aramid and it has been found that up to as much as 10 percent or more, by weight, of other polymeric material can be blended with the aramid. Copolymers can be used having as much as 10 percent or more of other diamine substituted for the diamine of the aramid or as much as 10 percent or more of other diacid chloride substituted for the diacid chloride or the aramid.

Para-aramid fibers containing polymeric materials as additives are spun from a blend of the two components in solution usually in sulfuric acid, so the polymeric materials must, in that case, be soluble and stable in sulfuric acid. Examples of polymeric materials that can be blended with the para-aramid include poly(l-vinyl-2-pyrrolidone) and copolymers, cycloaliphatic polyamides and aliphatic polyamides such as nylon 6 and nylon 66, meta-aramids such as poly(m-phenylene isophthalamide) and copolymers, and the like. The two-component fibers can contain 97 to 70 percent, preferably 90 to 80 percent, of the para-aramid and 3 to 30 percent, preferably 10 to 20 percent, of the polymeric material with the polymeric material present as a separate phase that disrupts the continuous fibrillar para-aramid phase. Thus the polymeric material promotes the formation of para-aramid fibrils with the polymeric material being concentrated at their surfaces during the refining and milling steps used to produce the micropulps required for this invention.

Another suitable fiber is one based on aromatic copolyamide such as is prepared by reaction of terephthaloyl chloride (TPA) with a 50/50 mole ratio of p-phenylene diamine (PPD) and 3,4′-diaminodiphenyl ether (DPE). Yet another suitable fiber is that formed by polycondensation reaction of two diamines, p-phenylene diamine and 5-amino-2-(p-aminophenyl) benzimidazole with terephthalic acid or anhydrides or acid chloride derivatives of these monomers.

When the polymer is polyazole, suitable polyazoles are polybenzazoles, polypyridazoles and polyoxadiazoles. Suitable polyazoles include homopolymers and, also, copolymers. Additives can be used with the polyazoles and up to as much as 10 percent, by weight, of other polymeric material can be blended with the polyazoles. Also copolymers can be used having as much as 10 percent or more of other monomer substituted for a monomer of the polyazoles. Suitable polyazole homopolymers and copolymers can be made by known procedures, such as those described in U.S. Pat. No. 4,533,693 (to Wolfe, et al., on Aug. 6, 1985), U.S. Pat. No. 4,703,103 (to Wolfe, et al., on Oct. 27, 1987), U.S. Pat. No. 5,089,591 (to Gregory, et al., on Feb. 18, 1992), U.S. Pat. No. 4,772,678 (Sybert, et al., on Sep. 20, 1988), U.S. Pat. No. 4,847,350 (to Harris, et al., on Aug. 11, 1992), and U.S. Pat. No. 5,276,128 (to Rosenberg, et al., on Jan. 4, 1994).

Preferred polybenzazoles are polyimidazoles, polybenzothiazoles, and polybenzoxazoles. If the polybenzazole is a polyimidazole, preferably it is poly[5,5′-bi-1H-benzimidazole]-2,2′-diyl-1,3-phenylene which is called PBI. If the polybenzazole is a polybenzothiazole, preferably it is a polybenzobisthiazole and more preferably it is poly(benzo[1,2-d:4,5-d′]bisthiazole-2,6-diyl-1,4-phenylene which is called PBT. If the polybenzazole is a polybenzoxazole, preferably it is a polybenzobisoxazole and more preferably it is poly(benzo[1,2-d:5,4-d′]bisoxazole-2,6-diyl-1,4-phenylene which is called PBO.

Preferred polypyridazoles are rigid rod polypyridobisazoles including poly(pyridobisimidazole), poly(pyridobisthiazole), and poly(pyridobisoxazole). The preferred poly(pyridobisazole) is poly(1,4-(2,5-dihydroxy)phenylene-2,6-pyrido[2,3-d:5,6-d′]bisimidazole which is called PB. Suitable polypyridobisazoles can be made by known procedures, such as those described in U.S. Pat. No. 5,674,969.

Preferred polyoxadiazoles include polyoxadiazole homopolymers and copolymers in which at least 50% on a molar basis of the chemical units between coupling functional groups are cyclic aromatic or heterocyclic aromatic ring units. A suitable polyoxadiazole is available under the tradenames Arselon®.

Almost all polyacrylonitrile (PAN) polymers are copolymers made from mixtures of monomers with acrylonitrile as the main component. In some production methods, small amounts of other vinyl comonomers of up to 10% are also used. As well as free radical polymerization, anionic polymerization also can be used for synthesizing PAN. For textile applications, molecular weights in the range of 40,000 to 70,000 are common.

The fibers are generally spun using an air gap spinning process such as is well known and is described in U.S. Pat. No. 3,767,756 or 4,340,559. Fibers are spun from an anisotropic spin dope, through an air gap, into an aqueous coagulating bath, and through an aqueous rinse and wash. The resulting as-spun fibers are so-called “never-dried” and include from 20 to 400 weight percent of water, typically about 40 weight percent for as-spun para-aramid fibers. Fibers that have been previously dried to less than 20 percent moisture have had their molecular structure and fibrillar morphology irreversibly collapsed and ordered into a compact fiber. In some embodiments of this invention, never-dried fibers are advantageous because they are more wettable, provide more porosity, and are more easily fibrillated during refining of pulp and wet milling of micropulp. While the never-dried fibers to be used may be partially dried, it is important that they have been newly-spun and have never been dried to less than 20 percent moisture.

### Elastomer

As used herein, the terms “rubber” and “elastomer” may be used interchangeably, unless otherwise provided. The terms “rubber composition”, “compounded rubber” and “rubber compound” may be used interchangeably to refer to “rubber which has been blended or mixed with various ingredients and materials” and such terms are well known to those having skill in the rubber mixing or rubber compounding art. The terms “cure” and “vulcanize” may be used interchangeably unless otherwise provided. In the description of this invention, the term “phr” refers to parts of a respective material per 100 parts by weight of rubber, or elastomer.

The elastomers of the present invention include both natural rubber, synthetic natural rubber and synthetic rubber. Synthetic rubbers compounds can be any which are dissolved by common organic solvents and can include, among many others, polychloroprene and sulfur-modified chloroprene, hydrocarbon rubber, butadiene-acrylonitrile copolymer, styrene butadiene rubber, chlorosulfonated polyethylene, fluoroelastomer, polybutadiene rubber, polyisoprene rubber, ethylene/propylene diene rubber, nitrile rubber, or ethylene-acrylic rubber, butyl and halobutyl rubber and the like. Natural rubber, styrene butadiene rubber, polyisoprene rubber and polybutadiene rubber are preferred. Mixtures of rubbers may also be utilized.

Carbon black and/or silica may also be present in the masterbatch with additional quantities being added at final compounding. The carbon black and silica primarily function as reinforcement fillers. The amounts of these materials will vary depending on the end use application and the final elastomeric composition. In some embodiments, carbon black is present in the final compound in an amount of from 40 to 100 phr and silica in an amount of up to 70 phr. A silica coupling agent may also be added.

### Process

The micropulp is dispersed in elastomer to form a masterbatch such as that described in the DuPont Kevlar® Engineered Elastomer Technical Bulletins Compound Development Guide and Processing Guide.

The micropulp masterbatch is then combined with additional elastomer and other ingredients to form a final compound that is then vulcanized to produce the desired article. An example of a typical mixing process that is representative of two-stage mixing of a Kevlar® Engineered Elastomer into a neoprene type rubber is:

### First Stage

1. Add successively, while mixing, half the neoprene rubber, then Kevlar® Engineered Elastomer, and finally the remaining neoprene and magnesium oxide
2. Mix effectively for 1-1.5 minutes
3. Add loose fibers (if any)
4. Mix at least 30 seconds
5. Add fillers, plasticizers, antioxidant and other additives
6. Increase mixer speed as needed to achieve the desired temperature and continue mixing until good dispersion of the fiber has been obtained,
7. Sheet off the first stage compound at a temperature not exceeding the temperature range of 105-110° C. and allow to cool.

### Second Stage

1. Add successively half the cooled product from the first stage, followed by zinc oxide, curatives and the remainder of the first pass mix.
2. Dump at 100-105° C. into a sheeting mill.

Other compound formulations and production techniques are widely available in the technical literature. Examples of vulcanized articles comprising fibrous micropulp of this invention include components for a tire, a power transmission belt, a conveyor belt, a gasket and other manufactured rubber goods.

### Test Methods

The specific surface area of the pulps was measured by nitrogen adsorption/desorption at liquid nitrogen temperature (77.3 K) using a Micromeritics ASAP 2405 porosimeter and expressed in units of square meter per gram (m²/g). Samples were out-gassed overnight at a temperature of 150° C., unless noted otherwise, prior to the measurements and the weight losses were determined due to adsorbed moisture. A five-point nitrogen adsorption isotherm was collected over a range of relative pressures, P/P₀, from 0.05 to 0.20 and analyzed according to the BET method (S. Brunauer, P. H. Emmett, and E. Teller, J. Am. Chem. Soc. 1938, 60, 309); P is the equilibrium gas pressure above the sample, P₀ is the saturation gas pressure of the sample, typically greater than 760 Torr.

The relative specific surface area of the milled micropulps was calculated from the relaxation times measured using low field NMR spectroscopy. A Bruker Minispec mq20 NMR (Bruker, Woodlands, Tex., US) was used operating at 20 MHz equipped with either an absolute probe for 18 or 10 mm diameter sample tubes. Milled micropulp dispersions at solid contents ranging from 0.01 to 2.10 weight percent were charged into the tubes in sufficient amounts to fill the homogeneous region of the radio frequency coil. The dispersions in the tubes were equilibrated in a temperature-controlled water bath at either 42 or 20° C., agitated to homogenize, then inserted into the probe for measurements at either 40 or 20° C. The proton spin-lattice relaxation times (T₁) were measured using an inversion recovery pulse sequence. The proton spin-spin relaxation times (T₂) were measured employing a Carr-Purcell-Meiboom-Gill pulse sequence, and 8000 evenly space echoes were sampled, typically with an echo spacing of 400 ρs (2*T, T=200 ρs). Dummy or skipped echoes were employed to extend the decay curve to >4*T₂. Often 1 scan was employed but occasionally 4 scans were employed with a recycle delay of 20 seconds. The T₁ and T₂ values were calculated by fitting the decay curves using MiniSpec Software. The surface area of the micropulp is related to T₂ by the following equation:

$$\frac{1}{T 2} = \frac{1}{T 2 bulk} + {ρ}_{2} ( \frac{S}{V} )$$

where T_{2bulk}=T₂ of the bulk fluid (water), ρ₂=surface relaxivity, S=surface area of sample and V=volume of water. The value of ρ₂ is a characteristic of a given solid/fluid pair. It can be determined if S is known from an independent measurement such as that described above for specific surface area by nitrogen adsorption/desorption. When ρ₂ is not known, the relative surface area of two samples: A and B, can be determined by ratios, which cancel out common ρ₂ and volume variables:

$$\frac{( \frac{1}{T 2 ( A )} - \frac{1}{T 2 bulk} )}{( \frac{1}{T 2 ( B )} - \frac{1}{T 2 bulk} )} = \frac{{S}_{A}}{{S}_{B}}$$

In practice, measurements are made for 3-4 dilutions of both samples and plotted to check linearity. The ratio of these slopes, instead of single point measurements, is used to calculate the relative specific surface area of sample A, where specific surface area of A=S_{A}/m_{A} and m_{A}=mass of A from the value of specific surface area measured for sample B. The relative specific surface area of the micropulps was calculated based on the specific surface area of 8.0 m²/g measured for a sample of 1F361 pulp by nitrogen adsorption/desorption.

Canadian Standard Freeness was measured according to standard test method TAPPI T 227 using a Canadian Standard Freeness Tester Model 33-23 supplied by Testing Machines Inc., New Castle, Del., which measures the facility for water to drain from an aqueous slurry or dispersion of a pulp and is inversely related to the degree of fibrillation of the pulp as a greater numbers of fibrils will reduce the rate at which water drains through the paper mat that forms during the test. Data obtained from the test under the standard conditions are expressed in milliliters of water that drain from a slurry of 3 grams of pulp in 1 liter of water. A lower value indicates that a more fibrillated pulp will retain more water and drain more slowly.

The fiber lengths of the fibrillated pulps were measured using a Fiber Expert tabletop analyzer supplied by from Metso Automation Inc., Kajaani, Finland. The analyzer takes photographic images of the pulp with a digital CCD camera as the pulp slurry flows through the analyzer and an integrated computer analyzes the fibers in these images to calculate their length expressed in millimeters as a volume weighted average. The volume average fiber lengths of the micropulps were measured using a LS200 laser diffraction analyzer supplied by Beckman Coulter Inc., Miami, Fla. and expressed in micrometers. As used herein, the volume average length means:

$$\frac{\sum ( \begin{matrix}number of fibers \\ of given length\end{matrix} ) \times {( length of each fiber )}^{4}}{\sum ( number of fibers of given length ) \times {( length of each fiber )}^{3}}$$

The tensile stress-strain measurements were performed according to ASTM D412-06a, method A, using an extensometer. Dumbbell tensile bars were cut using Die C as described in Method A. The tensile results are reported as the average of six samples.

### EXAMPLES

Abbreviations used in the examples and tables are as follows: mmole (millimole), wt (weight), CSF (Canadian Standard Freeness), T (temperature), MD (machine direction), XD (cross-machine direction), phr (parts per hundred rubber), ND (never-dried), SBR (styrene-butadiene rubber), BR (butadiene rubber).

The examples were prepared using the following materials: Alcogum® 6940 thickener (polyacrylic acid, sodium salt; 11% solids) and Alcogum® SL 70 dispersing agent (acrylate copolymer; 30% solids), Akzo Nobel Surface Chemistry, Chattanooga, Tenn.; Aquamix™ 125 (Wingstay® L, hindered polymeric phenolic antioxidant, 50% solids) and Aquamix™ 549 (zinc 2-mercaptotoluimidazole, 50% solids) dispersions, PolyOne Corp., Massillon, Ohio; Amax® OBTS accelerator (N-oxydiethylene-2-benzothiazole-sulfenamide) and AgeRite® Resin D antioxidant (polymerized 1,2-dihydro-2,2,4-trimethylquinoline), R. T. Vanderbilt Co., Norwalk, Conn.; DPG accelerator (diphenyl guanidine), Akrochem Corp., Akron, Ohio; Santoflex® 6PPD antiozonant (N-(1,3-dimethylbutyl)-N′-phenyl-para-phenylenediamine), Solutia/Flexsys America, Akron, Ohio; BUNA VSL 4526-2 HM styrene-butadiene rubber (solution polymerized, 27.3% TDAE oil extended), Lanxess, Orange, Tex.; Budene® 1207 (high-cis-polybutadiene), Goodyear Chemical, Akron, Ohio; Vulcan® 7H (N234 carbon black), Cabot, Alpharetta, Ga.; Zinc Oxide, Rubbermaker's Sulphur, Stearic Acid; Hyprene L2000 naphthenic process oil, Ergon Refining Inc., Jackson, Miss.; Nochek® 4729A microcrystalline wax, International Group, Toronto, ON; Wingstay 100 (diaryl-p-phenylenediamines), Hallstar, Chicago, Ill.; ZB 49 process aid, Struktol, Stow, Ohio; CBS accelerator (N-Cyclohexyl-2-benzothiazole sulfenamide), Solutia, Kingsport, Tenn. Commercial and experimental Kevlar® fibers were obtained from DuPont as 1F361 pulp (50% solids, CSF 168 mL, fiber length 1.09 mm), 1F178 floc (¼ inch), 1F561 floc (1.5 mm), never-dried as-spun cord (1500 denier, 1.5 denier per filament).

The following examples are given to illustrate the invention and should not be interpreted as limiting it in any way. All parts and percentages are by weight unless otherwise indicated. Examples prepared according to the process or processes of the current invention are indicated by numerical values. Control or Comparative Examples are indicated by letters. Data and test results relating to the Comparative and Inventive Examples are summarized in Tables 1 and 2.

### Comparative Example A

Kevlar® 1F361 pulp (40 g, 50% solids) was dispersed in water (1000 g) using a laboratory blender to give a homogeneous slurry. Alcogum® 6940 (10 g, 11% solids), Alcogum® SL 70 (2.2 g, 15% solids), Aquamix® 549 (4.1 g, 15% solids), and Aquamix® 125 (4.3 g, 14.5% solids) were added to the blender and dispersed into the slurry. Natural rubber latex (108 g, 62% solids) was added to the blender and dispersed into the slurry. The slurry was poured into an open container and the blender jar was rinsed with water to collect all of the slurry. The latex was coagulated by adding an aqueous solution containing calcium chloride (26 wt %) and acetic acid (5.2 wt %) with gentle stirring until the pH was between 5.8 and 5.2. The coagulated mass was collected and pressed to remove as much of the aqueous phase as possible. The mass was then dried overnight at 70° C. in a vacuum oven under nitrogen purge to give a masterbatch containing 23% pulp (30 phr).

A rubber compound containing 5 phr pulp was prepared by adding the following materials to a C. W. Brabender Prep-Mixer®: natural rubber (192.5 g), the masterbatch (50.25 g), stearic acid (6.94 g, 3 phr), zinc oxide (6.94 g, 3 phr), rubbermaker's sulfur (3.70 g, 1.6 phr), Amax® OBTS (1.85 g, 0.8 phr), DPG (0.92 g, 0.4 phr), Santoflex® 6PPD (4.62 g, 2 phr), and AgeRite® Resin D (2.31 g, 1 phr). The compound was mixed at 80-95° C. for 25-30 minutes at 75-100 rpm, then removed from the mixing chamber and blades. The compound was mixed further and homogenized using an EEMCO 2 roll laboratory mill with 6 inch by 12 inch wide rolls. The final compound was sheeted to a thickness of 2.0-2.2 mm.

Two 4 inch by 6 inch plaques were cut from the milled sheet in the machine direction, and another two plaques were cut in the cross-machine direction. The plaques were compression molded at 160° C. to cure the natural rubber. Dumbbell tensile bars were cut from the cured plaques. The properties of the starting pulp and the tensile properties of the cured rubber compound are shown in Table 1.

### Comparative Example B

Kevlar® 1F178 ¼ inch floc (2.25 kg or 5 lb) was dispersed in water (132 L) at a solids level of 1.7% and refined into pulp using a Sprout-Waldron 12″ single-disc refiner in recirculation mode. The disc gap was set to 0.13 mm and the floc slurry was fed at a throughput of 60 liters per minutes. The refiner was run in recirculation mode for 35 minutes (effectively 16 passes). The relative degree of fibrillation of the pulp was monitored by periodically measuring the CSF. The pulp slurry was dewatered and compressed to remove excess water. The final pulp contained 27% solids and showed CSF of 161 mL and fiber length of 0.56 mm. The specific surface area was 7.9 m²/g.

### Comparative Example C

The rubber compounding procedure of Comparative Example A was used without adding a pulp masterbatch to prepare a control sample containing no fiber.

### Example 1

Kevlar® 1F361 pulp was dispersed in water at a solids level of 2.0% then fed to a 1.5 liter media mill (Model HML-1.5 Supermill, Premier Mill Corporation, Reading, Pa.) containing 0.7-1.2 mm cerium-stabilized zirconia as the solid component at an 80% volume loading. The mill was run at a stirrer speed of 730 meters per minute (2400 fpm) and the pulp slurry was fed at a throughput of 0.25 liters per minute. The mill was run in recirculation mode for 60 minutes. The fiber length of the resulting micropulp was 80.5 micrometers. The relative specific surface area was 50 m²/g.

### Example 2

The procedure of Example 1 was repeated using a longer recirculation time of 240 minutes to give a micropulp with a fiber length of 33.3 micrometers. The relative specific surface area was 70 m²/g.

### Example 3

Kevlar® 1F561 1.5 mm floc was dispersed in water at a solids level of 1.7% and refined as described in Comparative Example B using a recirculation time of 15 minutes (effectively 7 passes) to give a pulp with CSF of 556 mL and fiber length of 0.73 mm.

A portion of the pulp was processed in the media mill as described in Example 1 using a recirculation time of 60 minutes to give a micropulp with a fiber length of 93 micrometers. The relative specific surface area was 320 m²/g.

### Example 4

A portion of the pulp from Example 3 was processed in the media mill as described in Example 1 using a longer recirculation time of 240 minutes to give a micropulp with a fiber length of 37.7 micrometers. The relative specific surface area was 350 m²/g.

### Example 5

Kevlar® never-dried as-spun cord was fed to a Lummus tow cutter (Model Mark IV, Lummus Industries, Columbus, Ga.) to cut it into 6 mm wet floc. The wet floc was then converted into pulp using the procedure of Comparative Example B with a recirculation time of 20 minutes (effectively 9 passes) giving a CSF of 255 mL and a fiber length of 0.99 mm.

A portion of the never-dried pulp was processed in the media mill as described in Example 1 using a recirculation time of 60 minutes to give a never-dried micropulp with a fiber length of 77.1 micrometers. The relative specific surface area was 370 m²/g.

### Example 6

A portion of the never-dried pulp from Example 5 was processed in the media mill as described in Example 1 using a longer recirculation time of 240 minutes to give a never-dried micropulp with a fiber length of 29.5 micrometers. The relative specific surface area was 340 m²/g.

The procedure of Comparative Example A was used to prepare masterbatches containing variable amounts of the micropulps of Examples 3 and 4 and the pulp of Comparative Example B, to convert them into their sheeted natural rubber compounds, including a Comparative Example C as a control sample containing no pulp, and to test the cured plaques for their tensile properties. The properties of the starting pulps and micropulps and their cured natural rubber compounds are shown in Table 1.

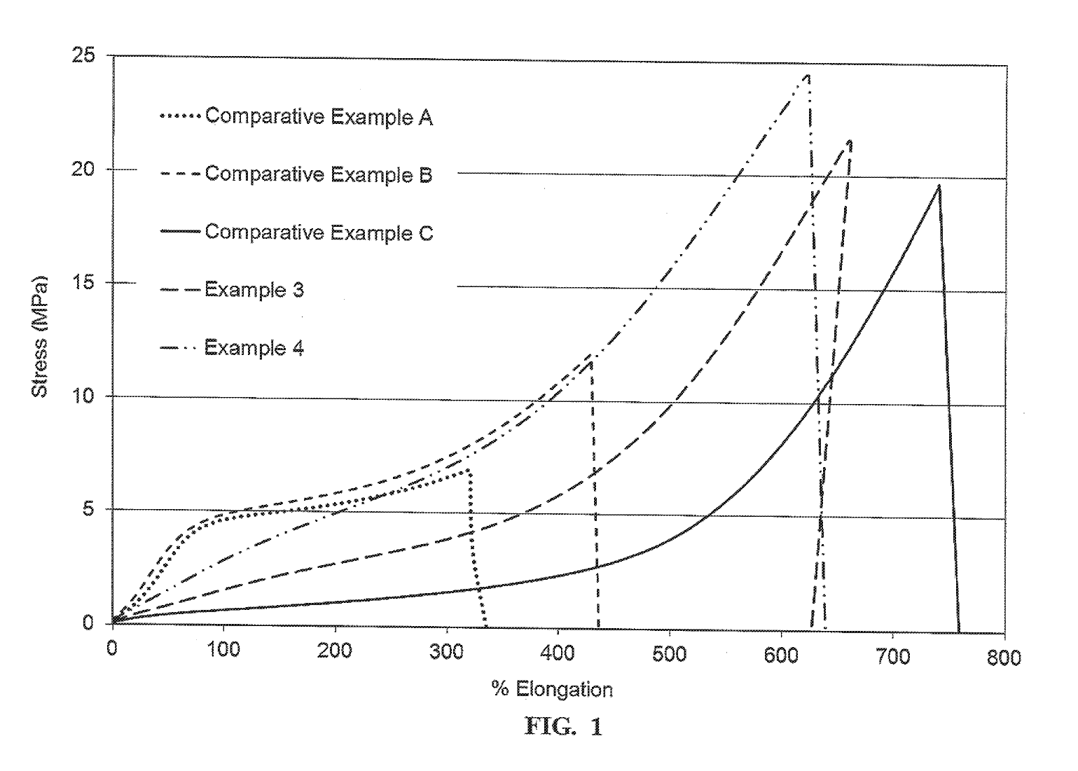

The masterbatches of the micropulps of Examples 3 and 4 impart a high degree of reinforcement to the cured natural rubber compounds over the entire strain range and do not show the characteristic yield point that is observed for the masterbatches of the commercial pulps and reach a higher elongation-to-break than do the commercial and lab-refined pulps prepared from standard dried fibers. See FIG. 1.

### Comparative Example D

Kevlar® 1F361 pulp (40 g, 50% solids) was dispersed in water (1000 g) using a laboratory blender to give a homogeneous slurry. Alcogum® 6940 (8.3 g, 11% solids), Alcogum® SL 70 (2.0 g, 15% solids), Aquamix® 549 (2.0 g, 15% solids), and Aquamix® 125 (1.9 g, 14.5% solids) were added to the blender and dispersed into the slurry. Natural rubber latex (111 g, 62% solids) was added to the blender and dispersed into the slurry. The slurry was poured into an open container and the blender jar was rinsed with water to collect all of the slurry. The latex was coagulated by adding an aqueous solution containing calcium chloride (26 wt %) and acetic acid (5.2 wt %) with gentle stirring until the pH was between 5.8 and 5.2. The coagulated mass was collected and pressed to remove as much of the aqueous phase as possible. The mass was then dried overnight at 70° C. in a vacuum oven under nitrogen purge to give a masterbatch containing 23% pulp (30 phr).

A rubber compound containing 3.5 phr pulp was prepared by adding the following materials to a C. W. Brabender Prep-Mixer®: oil-extended styrene butadiene rubber (125 g), polybutadiene rubber (36.4 g), the masterbatch (21.8 g), stearic acid (2.9 g), zinc oxide (3.6 g), carbon black N234 (109 g), Hyprene L2000 oil (22 mL), Nochek® 4729A wax (2.9 g), ZB 49 process aid (2.9 g), Santoflex® 6PPD (2.9 g), Wingstay 100 (0.73 g), rubbermaker's sulfur (2.9 g), CBS (2.5 g), and DPG (2.9 g).

The compound was mixed at 80-95° C. for 25-30 minutes at 75-100 rpm, then removed from the mixing chamber and blades. The compound was mixed further and homogenized using an EEMCO 2 roll laboratory mill with 6 inch by 12 inch wide rolls. The final compound was sheeted to a thickness of 2.0-2.2 mm.

Two 4 inch by 6 inch plaques were cut from the milled sheet in the machine direction, and another two plaques were cut in the cross-machine direction. The plaques were compression molded at 160° C. to cure the rubber. Dumbbell tensile bars were cut from the cured plaques. The properties of the starting pulp and the tensile properties of the cured rubber compound are shown in Table 2.

### Comparative Example E

The rubber compounding procedure of Comparative Example D was used without adding a pulp masterbatch and with oil-extended styrene butadiene rubber (150.4 g) and Hyprene L2000 oil (16 mL) to prepare a control sample containing no fiber.

### Comparative Example F

Kevlar®/12% PVP hybrid cord was fed to the Lummus tow cutter to cut it into ¼ inch floc. The floc was then converted into pulp using the procedure of Comparative Example B with a recirculation time of 25 minutes (effectively 12 passes) giving a CSF of 0 mL and a fiber length of 0.9 mm. The specific surface area was 26.6 m²/g by the BET method.

### Example 7

A portion of the hybrid pulp was processed in the media mill as described in Example 1 using a recirculation time of 60 minutes to give a hybrid micropulp with a fiber length of 40 micrometers. The relative specific surface area was 53 m²/g.

### Example 8

A portion of the hybrid pulp from Example 7 was processed in the media mill as described in Example 1 using a longer recirculation time of 240 minutes to give a hybrid micropulp with a fiber length of 22 micrometers. The relative specific surface area was 128 m²/g.

The procedure of Comparative Example D was used to prepare masterbatches containing the pulp of Comparative Example F and the micropulps of Examples 1, 2, 3′, 4′, 5, 6, 7, and 8 to convert them into their sheeted synthetic rubber compounds, including a Comparative Example E as a control sample containing no pulp, and to test the cured plaques for their tensile properties. The properties of the starting pulps and micropulps, and their cured synthetic rubber compounds are shown in Table 2. It should be noted that Examples 3′ and 4′ had the same micropulps as Examples 3 and 4, except that Examples 3′ and 4′ were made using synthetic rubbers having carbon black as an additive.

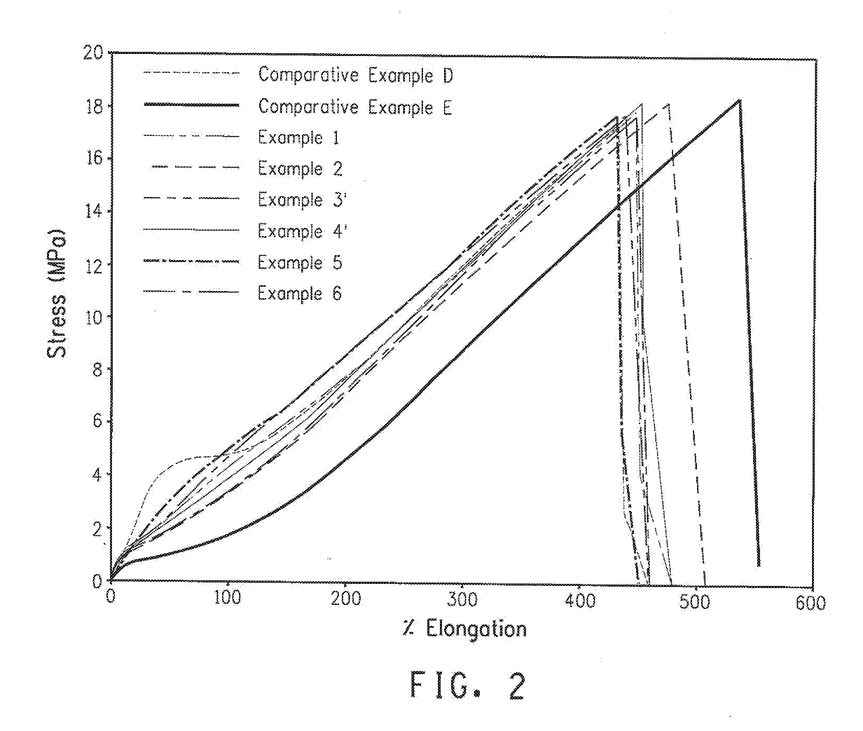

The masterbatches of the micropulps of Examples 1-6 impart a high degree of reinforcement to the cured synthetic rubber compounds over the entire strain range and do not show the characteristic yield point that is observed for the masterbatches of the commercial pulps. See FIG. 2.

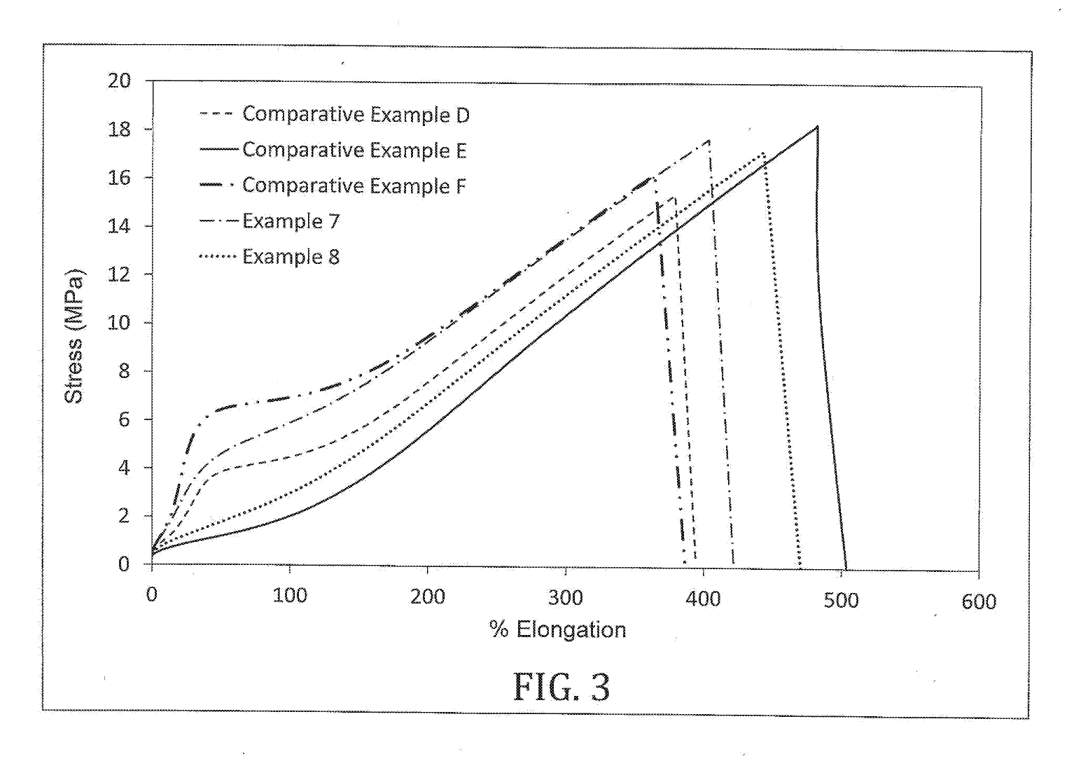

The masterbatches of the micropulps of Examples 7 and 8 impart an even higher degree of reinforcement than those of Examples 1-6 due to the presence of PVP in the starting Kevlar® fiber, yet still do not show the characteristic yield point that is observed for the masterbatches of commercial and PVP-containing pulps. See FIG. 3.

TABLE 1
(Vulcanized Natural Rubber Compounds)

| | Example | | | | | | | | |
|---|---|---|---|---|---|---|---|---|---|
| | A | | B | | C | 3 | | 4 | |
| Fiber | 1F361 | | 1F178 | | none | 1F561 | | 1F561 | |
| Refiner Time (min) | — | | 35 | | — | 15 | | 15 | |
| CSF (mL) | 168 | | 161 | | — | 556 | | 556 | |
| Volume Average Fiber Length (mm) | 1.09 | | 0.56 | | — | 0.73 | | 0.73 | |
| Mill Time (min) | — | | — | | — | 60 | | 240 | |
| Volume Average Fiber Length (μm) | — | | — | | — | 93 | | 37.7 | |
| Specific Surface Area (m²/g) | 8.0 | | 7.9 | | — | 320 | | 350 | |
| Pulp Loading (phr) | 5 | | 5 | | 0 | 2.5 | | 7.7 | |
| Test Direction | MD | XD | MD | XD | MD | MD | XD | MD | XD |
| Stress, 10% Strain (MPa) | 0.48 | 0.28 | 0.63 | 0.30 | 0.18 | 0.23 | 0.25 | 0.42 | 0.34 |
| Stress, 25% Strain (MPa) | 1.14 | 0.60 | 1.57 | 0.51 | 0.30 | 0.48 | 0.45 | 0.81 | 0.60 |
| Stress, 50% Strain (MPa) | 2.69 | 1.11 | 3.41 | 0.80 | 0.44 | 0.85 | 0.69 | 1.43 | 0.92 |
| Stress, 100% Strain (MPa) | 4.23 | 2.03 | 4.94 | 1.36 | 0.64 | 1.59 | 1.13 | 2.75 | 1.58 |
| Stress, 200% Strain (MPa) | 5.04 | 3.30 | 5.84 | 2.44 | 1.00 | 2.77 | 2.07 | 4.87 | 3.19 |
| Stress, 300% Strain (MPa) | 6.16 | 4.57 | 7.35 | 3.55 | 1.48 | 3.91 | 3.17 | 6.97 | 5.04 |
| Strain at Max Load (%) | 306 | 487 | 413 | 615 | 713 | 657 | 700 | 590 | 634 |
| Stress at Max Load (MPa) | 6.50 | 10.12 | 11.32 | 14.65 | 16.64 | 20.99 | 20.91 | 22.39 | 22.13 |

TABLE 2
(Vulcanized SBR/BR/N234 Rubber Compounds)

| | Example | | | | | | | | | | |
|---|---|---|---|---|---|---|---|---|---|---|---|
| | D | | E | F | | 1 | | 2 | | 3′ | |
| Fiber | 1F361 | | none | 12% PVP | | 1F361 | | 1F361 | | 1F561 | |
| Refiner | — | | — | 25 | | — | | — | | 15 | |
| Time (min) | | | | | | | | | | | |
| CSF (mL) | 168 | | — | 0 | | 168 | | 168 | | 556 | |
| Volume Average | 1.09 | | — | 0.9 | | 1.09 | | 1.09 | | 0.73 | |
| Fiber Length (mm) | | | | | | | | | | | |
| Mill Time (min) | — | | — | — | | 60 | | 240 | | 60 | |
| Volume Average | — | | — | — | | 80.5 | | 33.3 | | 93 | |
| Fiber Length (μm) | | | | | | | | | | | |
| Specific Surface | 8.0 | | — | 26.6 | | 50 | | 70 | | 320 | |
| Area (m²/g) | | | | | | | | | | | |
| Pulp Loading | 3.5 | | 0 | 3.5 | | 3.5 | | 3.5 | | 3.5 | |
| (phr) | | | | | | | | | | | |
| Test Direction | MD | XD | MD | MD | XD | MD | XD | MD | XD | MD | XD |
| Stress, 10% | 0.84 | 0.54 | 0.56 | 1.52 | 0.78 | 0.90 | 0.48 | 0.95 | 0.81 | 1.27 | 0.97 |
| Strain (MPa) | | | | | | | | | | | |
| Stress, 25% | 1.65 | 0.98 | 0.88 | 4.65 | 1.07 | 1.70 | 0.95 | 1.34 | 1.11 | 2.14 | 1.25 |
| Strain (MPa) | | | | | | | | | | | |
| Stress, 50% | 4.24 | 1.45 | 1.15 | 6.73 | 1.40 | 2.88 | 1.31 | 1.94 | 1.45 | 3.52 | 1.65 |
| Strain (MPa) | | | | | | | | | | | |
| Stress, 100% | 5.24 | 2.26 | 1.78 | 7.22 | 2.22 | 4.58 | 2.09 | 3.31 | 2.34 | 5.25 | 2.67 |
| Strain (MPa) | | | | | | | | | | | |
| Stress, 200% | 7.43 | 4.62 | 4.34 | 9.69 | 5.18 | 7.82 | 4.78 | 7.12 | 5.46 | 8.48 | 5.95 |
| Strain (MPa) | | | | | | | | | | | |
| Stress, 300% | 11.5 | 8.16 | 8.59 | 13.8 | 9.23 | 11.9 | 8.33 | 11.4 | 9.37 | 12.5 | 9.81 |
| Strain (MPa) | | | | | | | | | | | |
| Strain at Max | 430 | 472 | 539 | 371 | 392 | 443 | 481 | 466 | 468 | 420 | 470 |
| Load (%) | | | | | | | | | | | |
| Stress at Max | 16.7 | 13.8 | 17.8 | 16.5 | 12.8 | 17.5 | 14.9 | 18.0 | 15.8 | 17.2 | 16.1 |
| Load (MPa) | | | | | | | | | | | |

| | Example | | | | | | | | | |
|---|---|---|---|---|---|---|---|---|---|---|
| | 4′ | | 5 | | 6 | | 7 | | 8 | |
| Fiber | 1F561 | | ND | | ND | | 12% PVP | | 12% PVP | |
| Refiner | 15 | | 20 | | 20 | | 25 | | 25 | |
| Time (min) | | | | | | | | | | |
| CSF (mL) | 556 | | 255 | | 255 | | 0 | | 0 | |
| Volume Average | 0.73 | | 0.99 | | 0.99 | | 0.9 | | 0.9 | |
| Fiber Length (mm) | | | | | | | | | | |
| Mill Time (min) | 240 | | 60 | | 240 | | 60 | | 240 | |
| Volume Average | 37.7 | | 77.1 | | 29.5 | | 40.0 | | 22.0 | |
| Fiber Length (μm) | | | | | | | | | | |
| Specific Surface | 350 | | 370 | | 340 | | 53 | | 128 | |
| Area (m²/g) | | | | | | | | | | |
| Pulp Loading | 3.5 | | 3.5 | | 3.5 | | 3.5 | | 3.5 | |
| (phr) | | | | | | | | | | |
| Test Direction | MD | XD | MD | XD | MD | XD | MD | XD | MD | XD |
| Stress, 10% | 1.06 | 0.96 | 1.28 | 0.89 | 1.00 | 0.89 | 1.68 | 0.88 | 0.89 | 0.77 |
| Strain (MPa) | | | | | | | | | | |
| Stress, 25% | 1.55 | 1.26 | 2.22 | 1.17 | 1.35 | 1.18 | 3.54 | 1.15 | 1.23 | 1.04 |
| Strain (MPa) | | | | | | | | | | |
| Stress, 50% | 2.34 | 1.61 | 3.61 | 1.53 | 1.93 | 1.54 | 4.85 | 1.50 | 1.76 | 1.37 |
| Strain (MPa) | | | | | | | | | | |
| Stress, 100% | 3.93 | 2.56 | 5.28 | 2.44 | 3.28 | 2.46 | 6.09 | 2.42 | 2.92 | 2.23 |
| Strain (MPa) | | | | | | | | | | |
| Stress, 200% | 7.80 | 5.78 | 8.61 | 5.60 | 7.17 | 5.70 | 9.48 | 5.65 | 6.67 | 5.47 |
| Strain (MPa) | | | | | | | | | | |
| Stress, 300% | 12.1 | 9.72 | 12.7 | 9.49 | 11.6 | 9.74 | 13.8 | 9.75 | 11.1 | 9.61 |
| Strain (MPa) | | | | | | | | | | |
| Strain at Max | 453 | 477 | 437 | 456 | 458 | 441 | 398 | 408 | 437 | 416 |
| Load (%) | | | | | | | | | | |
| Stress at Max | 18.1 | 16.4 | 17.7 | 15.3 | 17.7 | 15.0 | 17.7 | 14.0 | 16.9 | 14.2 |
| Load (MPa) | | | | | | | | | | |

What is claimed is:

1. A vulcanized article, comprising elastomer and fibrous micropulp wherein the micropulp:
(i) comprises fibers having a volume average fiber length of from 20 to 200 micrometers as measured by laser diffraction,
(ii) has a relative specific surface area of from 30 to 600 square meter per gram as measured by nuclear magnetic resonance, and
(iii) comprises fibers selected from the group consisting of aromatic polyamide, aromatic copolyamide, polyacrylonitrile or polyazole,
and wherein the vulcanized article does not exhibit a yield point.

2. The article of claim 1, wherein the relative specific surface area of the micropulp is from 40 to 250 square meter per gram.

3. The article of claim 1, wherein the fibers have a volume average fiber length of from 20 to 100 micrometers.

4. The article of claim 1, wherein the aromatic polyamide is para-aramid.

5. The article of claim 1, wherein the elastomer is selected from the group consisting of natural rubber, synthetic natural rubber and synthetic rubber.

6. The article of claim 1, wherein the elastomer further comprises carbon black or silica.

7. The article of claim 1, wherein the micropulp is a never-dried micropulp.

8. The article of claim 1, wherein the fiber comprises 97 to 70 percent para-aramid and 3 to 30 percent polymeric material with the polymeric material present as a separate phase that disrupts the continuous fibrillar para-aramid phase.

9. The article of claim 3, wherein the fibers have a volume weighted average fiber length of from 40 to 100 micrometers.

10. The article of claim 5, wherein the synthetic rubber is selected from the group consisting of polychloroprene, sulfur-modified chloroprene, hydrocarbon rubber, butadiene-acrylonitrile copolymer, styrene butadiene rubber, chlorosulfonated polyethylene, fluoroelastomer, polybutadiene rubber, polyisoprene rubber, butyl rubber or halobutyl rubber, ethylene/propylene diene rubber, nitrile rubber, and ethylene-acrylic rubber.

11. The article of claim 8, wherein the polymeric material is selected from the group consisting of polyvinylpyrrolidone, cycloaliphatic polyamides, aliphatic polyamides, and poly(m-phenylene isophthalamide).
